(19) United States
(12) Patent Application Publication
(10) Pub. No.: US 2011/0187067 A1
(43) Pub. Date: Aug. 4, 2011

(54) Shower chair/walker combination

(76) Inventor: Gary M. Staggs, Colleyville, TX (US)

(21) Appl. No.: 12/656,506

(22) Filed: Feb. 1, 2010

(51) Int. Cl. A61H 3/04; A61H 3/00; A47K 3/12

(52) U.S. Cl. 280/30; 135/66

(57) ABSTRACT

The shower chair/walker combination incorporates the features of a walker and a shower chair into a single appliance. The appliance includes a folding walker having a pivoted seat thereon. The seat is of a split toilet seat design, having a gap at its front end. This feature allows a caregiver to have access to all parts of the patient's body to assure complete bathing. The appliance is provided with brakes and controls therefor, as is conventionally provided for walkers. All moving parts are either covered to prevent rusting or fabricated from rust-resistant materials.

### BACKGROUND OF THE INVENTION

1. Field of the Invention

The present invention generally relates to medical appliances, and particularly to a shower chair/walker combination that provides a walker that is also usable as a shower chair for the disabled.

2. Description of the Related Art

In hospitals, nursing facilities and even in the private home, it is often necessary for a disabled and/or elderly patient to have a shower for adequate cleansing. Often, this endeavor requires the use of two appliances. One appliance (a walker or wheelchair) is needed to transport the patient to the shower area. A second appliance is needed to provide support while the patient is actually taking the shower. The use of walkers or wheelchairs for providing mobility for disabled people is a well-known concept in the related medical arts. So to is the use of shower chairs for people who find it difficult to stand while taking a shower. A variety of walkers, wheelchairs and shower chairs are disclosed in the related arts and are commercially available. It would certainly be advantageous if these appliances could be combined into a single appliance for accomplishing the task as described above. Thus, a shower chair/walker combination solving the aforementioned problems is desired.

### SUMMARY OF THE INVENTION

The shower chair/walker combination incorporates the features of a walker and a shower chair. The combination comprises a folding walker having a pivoted seat thereon. The seat is of a split toilet seat design having a gap at its front end. This feature allows a caregiver to have access to all parts of the patient's body to assure complete bathing. The appliance is provided with brakes and controls therefor as is conventionally provided for walkers. All moving parts are either covered to prevent rusting or fabricated from rust-resistant materials.

Accordingly, the invention presents a medical appliance that can be employed as a walker or a shower chair. The appliance is provided with wheels for easy movement. The appliance is also foldable to enhance storage capability. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a shower chair/walker combination according to the present invention.

FIG. 2 is a perspective view of a shower chair/walker combination according to the present invention.

FIG. 3 is a perspective, rear view of a shower chair/walker combination according to the present invention in a folded position.

FIG. 4 is a perspective, side view of a shower chair/walker combination according to the present invention in a folded position.

Similar reference characters denote corresponding features consistently throughout the attached drawings.

### DETAILED DESCRIPTION OF THE PREFERRED EMBODIMENTS

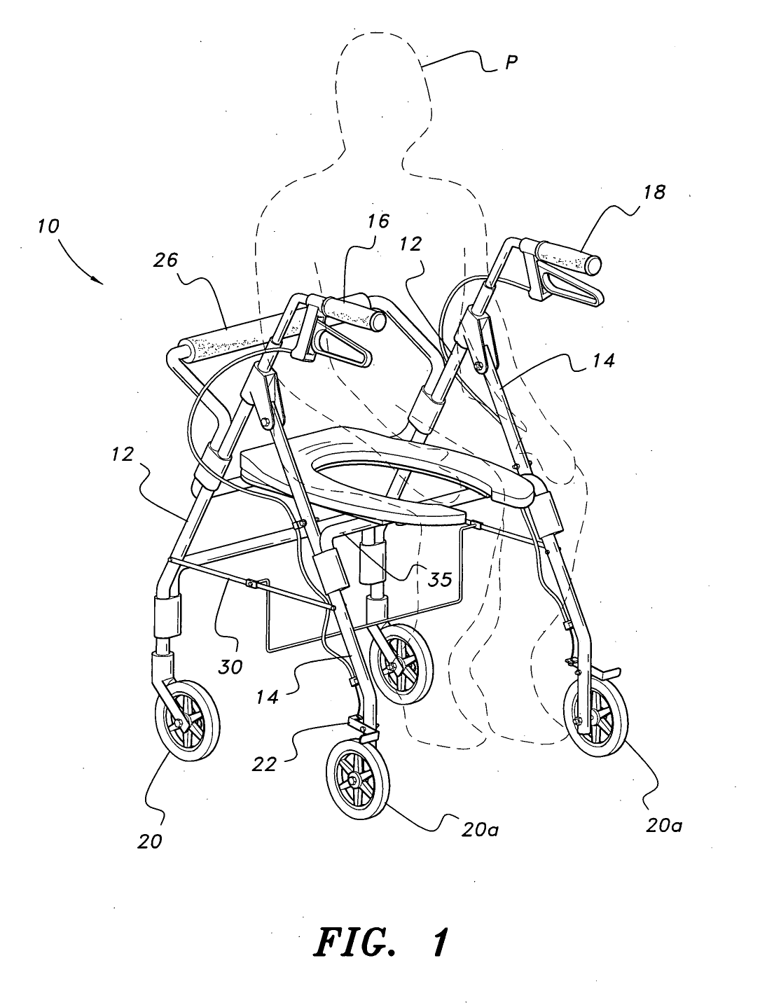

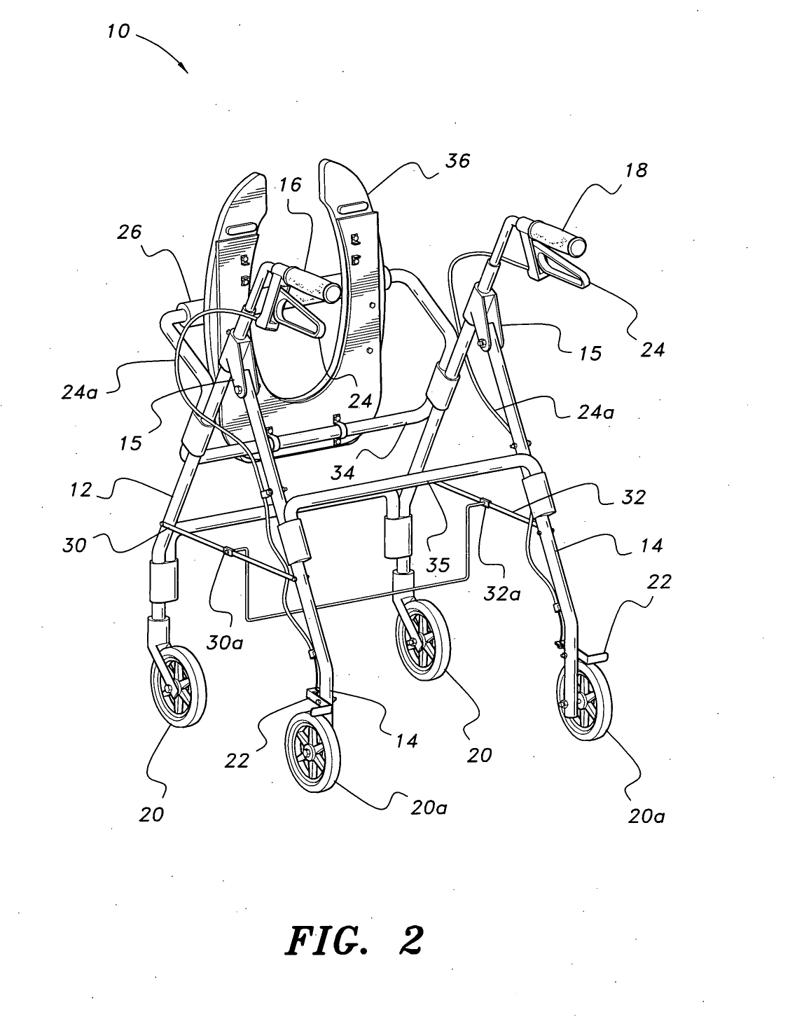

Referring to FIGS. 1 and 2, the shower walker/chair 10 comprises a pair of tubular front frame members 12 and a pair of tubular rear frame members 14. Front frame members are pivotally attached to rear frame members 12 at pivot connections 15. First and second handle members 16 and 18 are disposed in front frame members 12 and are telescopically adjustable therein to accommodate patients of different heights. The lower ends of frame members 12 and 14 are provided with respective front casters 20 and rear casters 20a to facilitate movement.

Braking elements 22 are positioned adjacent rear casters 20a. Brake controls 24 are mounted on handle members 16 and 18 and function to operate braking elements 22 via control lines 24a. A padded backrest member 26 is mounted to front frame member 12 to enhance the comfort of the patient when seated. Side support members 30 and 32 are attached to the front and rear frame members to provide stability. Side support members 30 and 32 are hinged at their respective centers 30a and 32a to accommodate folding.

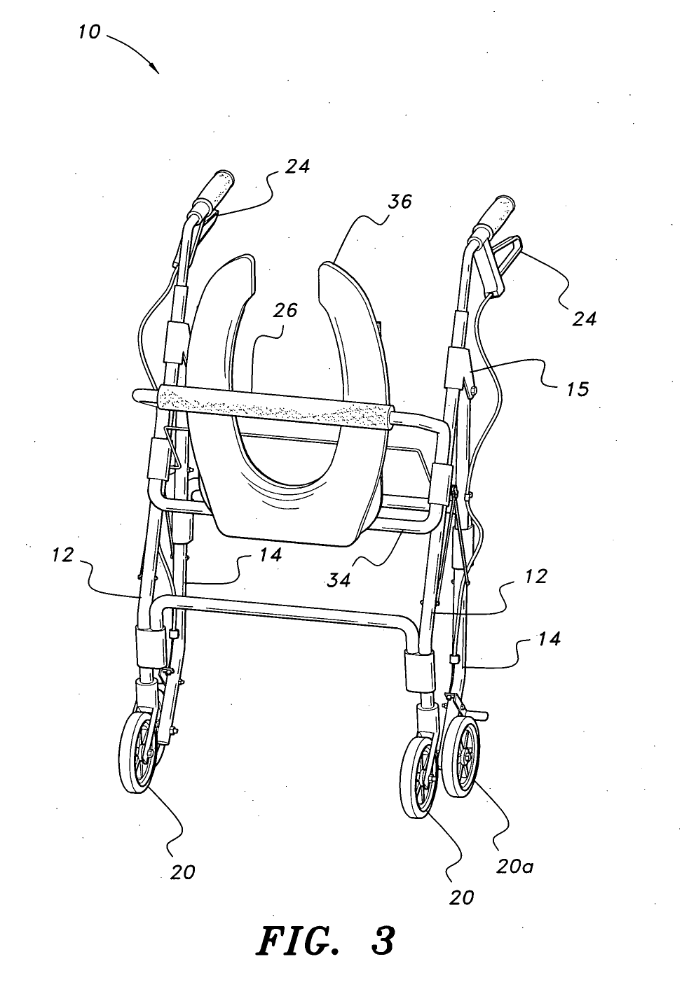

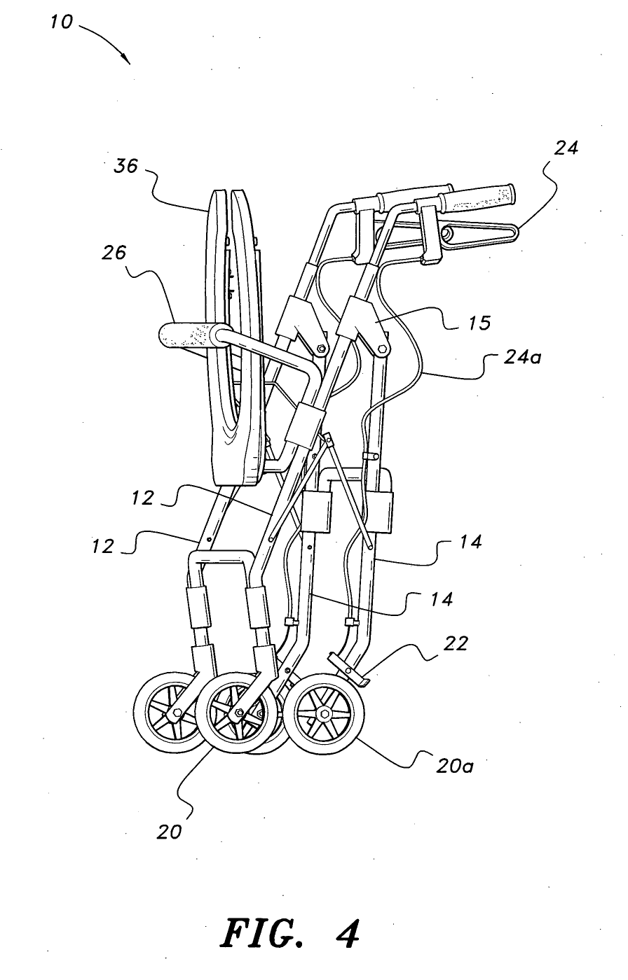

A front cross-brace 34 is attached to front frame members 12 and is adapted to secure a seat 36 pivotally attached thereto. The seat 36 has a configuration similar to that of a split toilet seat, which split toilet seat has a gap at its front end. A rear cross-brace member 35 is attached to rear frame members 14. The front end of seat 36 is supported on rear cross-brace member 35 when the seat is pivoted to an in use or downward position. The seat design permits a caregiver to have access to the patient's entire body thereby ensuring thorough cleansing. As best seen in FIGS. 3 and 4, the appliance is easily folded for storage when desired.

In use, patient P (shown in phantom lines) can employ the appliance as a walker or, alternatively, be transported to the shower area while seated on the appliance. The appliance and the seated patient are positioned in the shower thereby affording an opportunity for through bathing by a caregiver or the like.

It is to be understood that the present invention is not limited to the embodiment described above, but encompasses any and all embodiments within the scope of the following claims.

1. A shower chair/walker combination, comprising:
a front frame member;
a rear frame member pivotally attached to the front frame member;
a front cross-brace member attached to the front frame member;
a rear cross-brace member attached to the rear frame member;
a seat pivotally mounted on the front frame member, the seat having a front end, the seat being configured as a split toilet seat having a gap at the front end.

2. The shower chair/walker combination according to claim 1, further including a padded backrest attached to said front frame member.

3. The shower chair/walker combination according to claim 1, wherein said front frame member has a lower end, the combination further including casters mounted on the lower end.

4. The shower chair/walker combination according to claim 1, wherein said rear frame member has a lower end, the combination further including casters mounted on the lower end of said rear frame member.

5. The shower chair/walker combination according to claim 1, further including a pair of handles telescopically mounted on said front frame member.

6. The shower chair/walker combination according to claim 1, wherein the combination is fabricated from lightweight, rust resistant materials.

7. A shower chair/walker combination, comprising:
a front frame member having a lower end;
a rear frame member pivotally attached to the front frame member, the rear frame member having a lower end;
a first pair of casters mounted on the lower end of the front frame member;
a second pair of casters mounted on the lower end of the rear frame member;
a front cross-brace member attached to the front frame member;
a rear cross-brace member attached to the rear frame member;
a seat pivotally mounted on the front frame member, the seat having a front end, the seat being configured as a split toilet seat having a gap at the front end.

8. The shower chair/walker combination according to claim 7, wherein said seat is pivotally mounted on said front cross-brace member.

9. The shower chair/walker combination according to claim 7, further including braking elements positioned adjacent said second pair of casters.

10. The shower chair/walker combination according to claim 7, further including a padded backrest attached to said front frame member.

11. The shower chair/walker combination according to claim 7, further including a pair of handles telescopically mounted on said front frame member.

12. The shower chair/walker combination according to claim 7, wherein the combination is fabricated from lightweight, rust resistant materials.

13. A shower chair/walker combination, comprising:
a front frame member having a lower end;
a rear frame member pivotally attached to the front frame member, the rear frame member having a lower end;
a first pair of casters mounted on the lower end of the front frame member;
a second pair of casters mounted on the lower end of the rear frame member;
braking elements positioned adjacent the second pair of casters a front cross-brace member attached to the front frame member;
a rear cross-brace member attached to the rear frame member; and
a seat pivotally mounted on the front cross brace member, the seat having a front end, the seat being configured as a split toilet seat having a gap at the front end.

14. The shower chair/walker combination according to claim 13, further including a pair of handles telescopically mounted on said front frame member.

15. The shower chair/walker combination according to claim 14, wherein the combination is fabricated from lightweight, rust resistant materials.
